(19) United States
(12) Patent Application Publication
(10) Pub. No.: US 2002/0066347 A1
(43) Pub. Date: Jun. 6, 2002

(54) Cutting and transport roller with integrated cutter with rotating cutting surfaces

(76) Inventor: Franz Plasswich, Bremen (DE)

Correspondence Address: JACOBSON HOLMAN PLLC, 400 SEVENTH STREET, N.W., Washington, DC, 20004, US

(21) Appl. No.: 09/960,729

(22) Filed: Sep. 24, 2001

(30) Foreign Application Priority Data
Sep. 22, 2000 (DE) 100 47 545.0

(51) Int. Cl. B26D 1/56

(52) U.S. Cl. 83/338; 83/343

(57) ABSTRACT

The invention relates to a cutting and transport roller (1) and a process for cutting the material webs (7), which rest on the peripheral surface (3) of the cutting and transport roller. In so doing, the material webs (7) are severed with the aid of a cutter (4), which is located in essence inside the shell of the cutting and transport roller (1) in its resting position and which exhibits at least one knife (9), which during the cutting process of the material web reaches through an opening (6) of the shell of the cutting and transport roller. The cutting motion, which is executed by the cutting surfaces (9a, 9b) of at least one knife during the cutting process, exhibits rotary components, whereby the rotational motions of at least one knife (9) run about the axes (D, 36), which are either parallel or at an acute angle to a perpendicular line on the plane, which is defined by the radial (r) and axial (z) coordinates of the cutting and transport roller.

The invention relates to a cutting and transport roller with integrated cutter in accordance with the preamble of claim 1 and a process for cutting a material web with the aid of such a roller.

Cutting and transport rollers of the aforementioned kind are known. The EP 0 698 571 A2 shows a cutting and transport roller, which exhibits an outer shell, provided with a slotted opening, and contains a cutter for material webs. Said cutter severs the material webs, resting on the peripheral surface of the transport roller. This cutter exhibits a cutter bar with a knife with a serrated cutting surface.

The cutter bar is hinged to the cutter. During the cutting process of the material webs, resting on the cutting and transport roller, knife and cutter bar execute a translational motion in the radial direction of the cutting and transport roller, whereby at least the knife reaches through the slit in the shell and pierces the film. After the cutting process knife and cutter bar are withdrawn again into the interior of the roller.

Devices of the described type are mechanically complicated, because the forces required to sever the material webs are large. Moreover, after the completed cutting process, knife and cutter bar have to be withdrawn into the interior of the roller, which is rotating in the normal case. In this process the force, generated by the cutter, has to overcome a significant. centrifugal acceleration, which acts on the knife and cutter bar.

The large force, generated by the cutter during the cutting process, is transferred at least partially to the material web and has to be compensated for there, for example, by means of complicated vacuum or suction mechanisms, which are supposed to prevent the material web from being pushed away and then sliding off the roller.

Therefore, the present invention is based on the problem of reducing the mechanical complexity of such a device.

This problem is solved in that the cutter, integrated into the roller, is assigned at least one knife, which is linked to a knife holder so as to swivel, whereby the swivelable coupling of said at least one knife defines for said at least one cutting edge of the knife an axis of rotation, which runs either parallel or at an acute angle to a perpendicular line on the plane, which is defined by the radial (r) and the axial (z) coordinates of the cutting and transport roller.

Owing to these measures, the cutting blades of at least one knife execute during the cutting process a motion, which includes at least rotary components.

The inventive design of a cutting and transport roller has a number of advantages.

For example, during the cutting motion with exclusively rotary components, only said at least one knife, but not the generally heavy cutter bar is moved.

In addition to the simpler mechanical design of the cutting mechanism, the complexity, caused by the necessity to hold the film on the roller according to the state of the art, is also reduced. In a cutting process, which is carried out exclusively by means of a translation of the knife in the radial direction of the roller, the film is also forced outwards exclusively in the radial direction.

In a device, according to the invention, the cutting knives can be positioned in such a manner that the film is pushed away from the roller only during the first half of the piercing procedure. During this period, however, the film is only perforated and not yet completely severed. Therefore, the film is held anyway largely on the roller due to its looping around the roller on both sides of the perforation and due to the still existing web tension.

After the rotational motion of the knife blades in the radial direction has surpassed its apex, the rotational motion of the knife acts radially in the direction of the main axis of symmetry of the roller and counteracts in this manner a lifting of the material web from the roller. In light of the centrifugal acceleration, which acts on this material web, when the roller rotates around its main axis of symmetry, this state is very advantageous.

The described advantages still remain, even when translational motion components are superposed on the rotational motion of the invention. This requirement can be converted mechanically in the radial direction by means of the motion of the cutter bar.

However, in light of the enormous centrifugal forces owing to the high roller speed, generated in the interim, a device, according to the invention, can also be provided to its advantage with vacuum and suction mechanisms, which prevent the material web from being lifted from the roller especially after the cutting process.

Above all, a device, according to the invention, can make do with a plurality of knives with very thin blades. Therefore, in a device of this type economical industrial knives or knives of ground thin sheet steel can also be used.

In a device with a plurality of knives it is advantageous, if the spacing between the knives is less than or equal to the length of the cut, to be affixed into the material web during the cutting process.

In this manner it is guaranteed that the web will be cleanly and completely severed. In devices that do not guarantee a continuous cut over the entire web width, it is still possible to sever the web by tearing through the rest of the material, for example, as a consequence of the effect of the centrifugal force. However, this effect is usually undesired.

Another possibility to guarantee a complete, clean severing of the web lies in a translation of the cutter, preferably in the axial direction during the cutting process.

If the cutting process is performed by a plurality of knives, the cutting processes are advantageous, wherein the different knives make contact with the material web at different times. In this manner the force or torque complexity of the cutting process is reduced. Advantageous devices to carry out such a process include, for example, knives of varying lengths or knives suspended from points of rotation and that are positioned so as to be offset in the radial direction of the roller.

Another advantageous method for carrying out the process of the invention can be carried out with the aid of a circular cutter, which can be designed similar to a circular saw. Such a circular cutter provides advantageously a torque with the aid of an electric motor and consequently puts a substantially circular disk-shaped knife into an inventive rotational motion around its main axis of symmetry. To sever cleanly wide material webs over their entire width, the thin, substantially circular knife can be moved in the axial direction of the roller.

Other features and advantages of the invention are disclosed in the other dependent claims and the following description in conjunction with the drawings, in which the embodiments of the invention are depicted as schematic drawings.

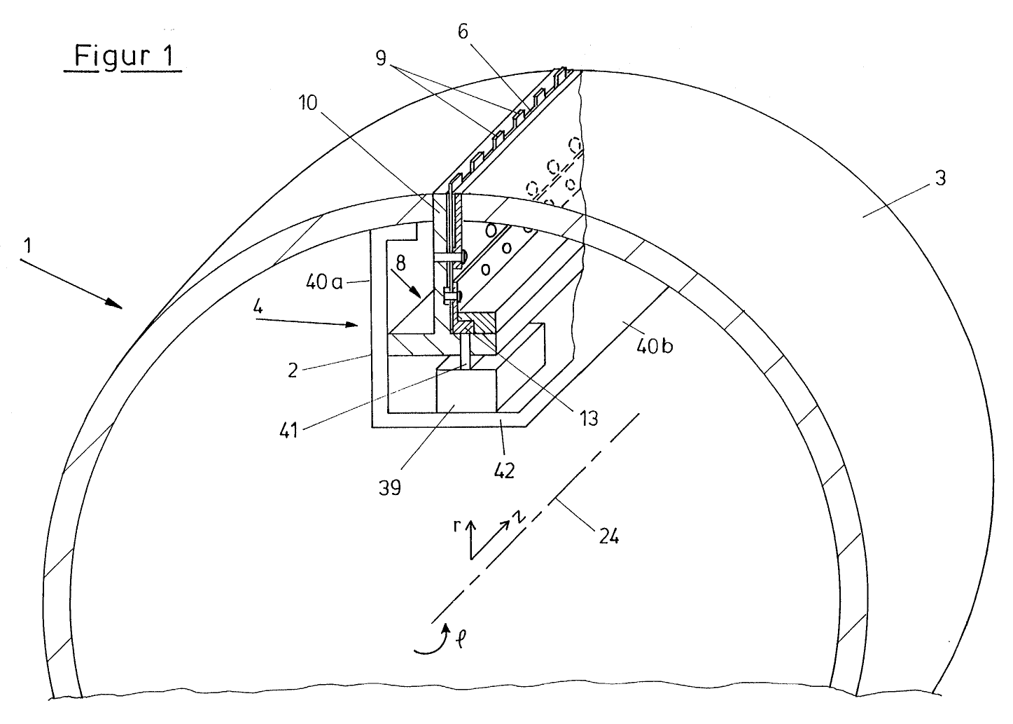

FIG. 1 is a sectional view of a cutting and transport roller.

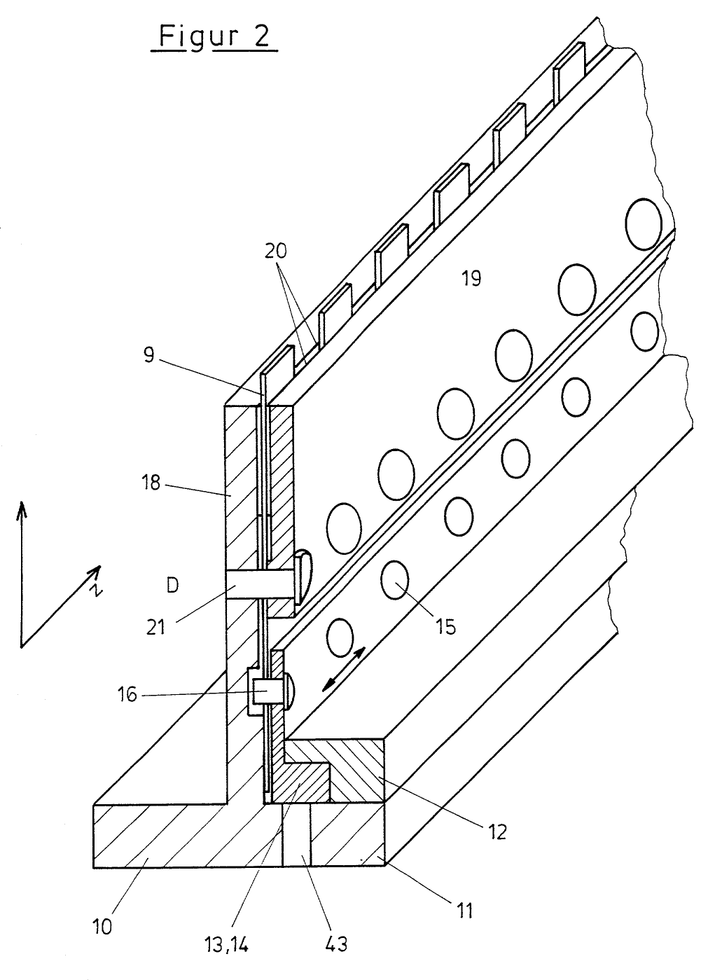

FIG. 2 is a schematic drawing of a cutter with several knives. The cutter containing roller is not illustrated.

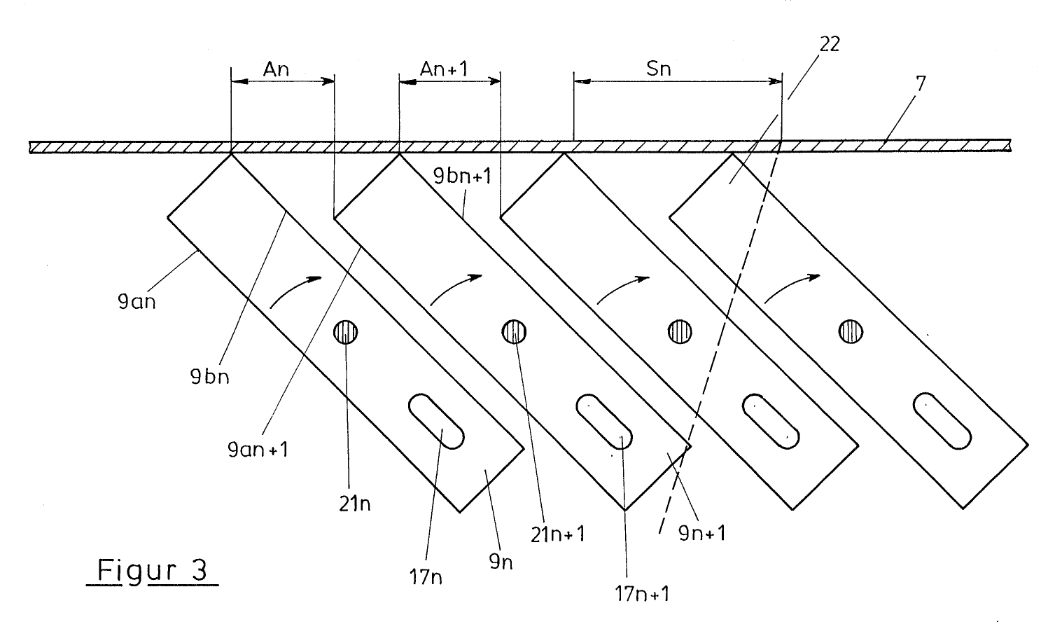

FIG. 3 is a graphical presentation of the cutting motion of several knives.

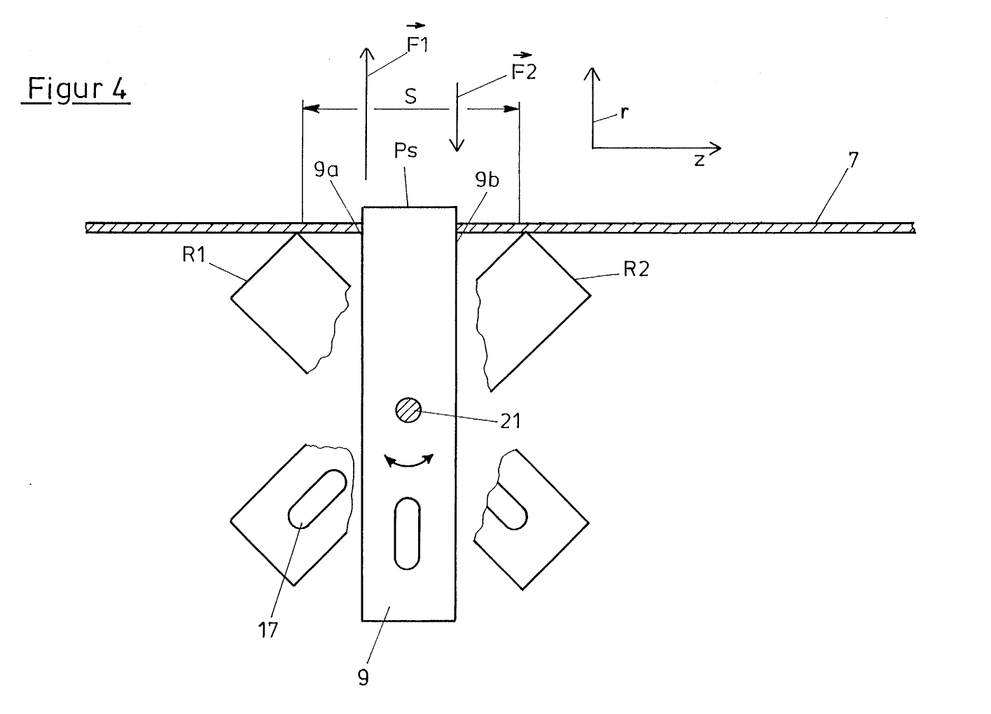

FIG. 4 is a graphical presentation of various phases of the cutting motion of a knife.

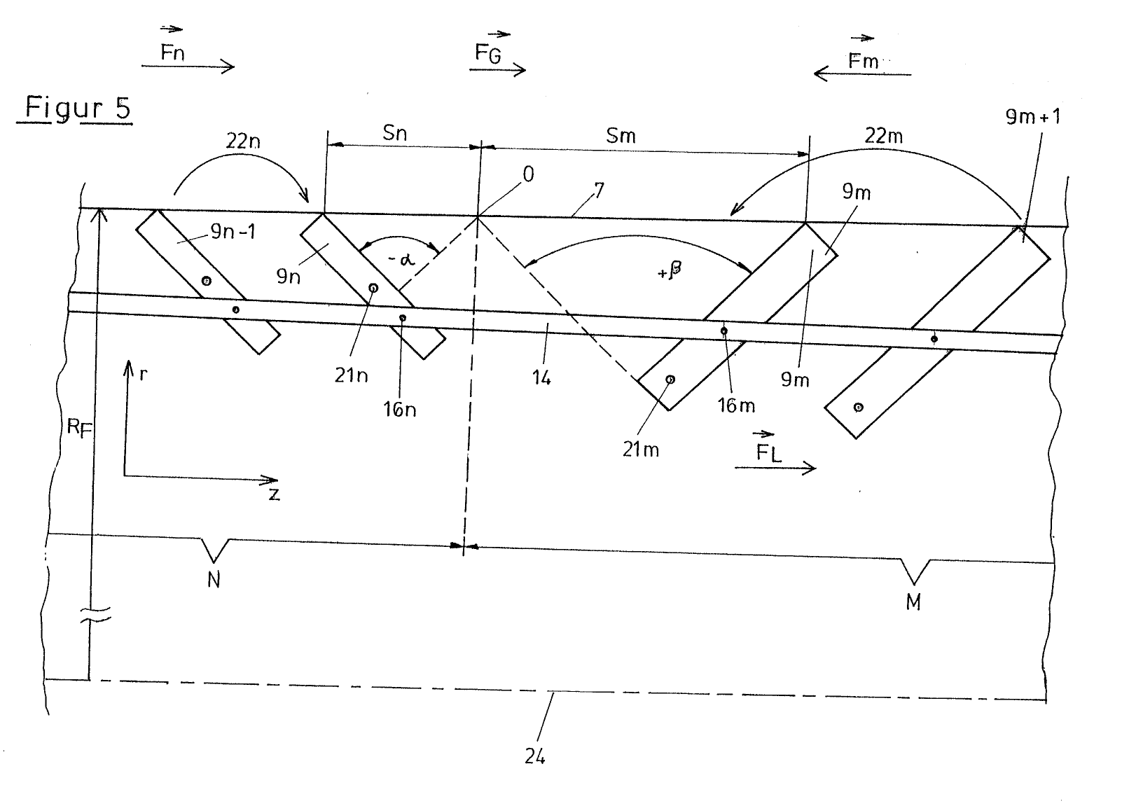

FIG. 5 is a sketch of a cutting process, wherein two groups of knives perform rotational motions in the counterclockwise direction during the cutting process.

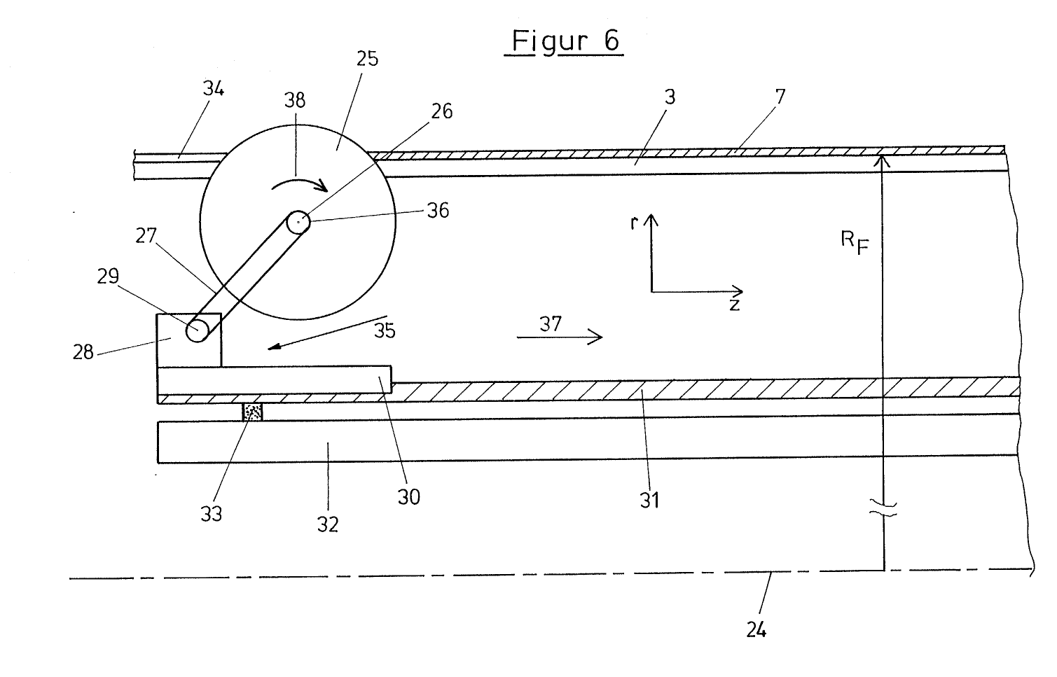

FIG. 6 is a sectional view of a cutting and transport roller, which contains a circular cutter.

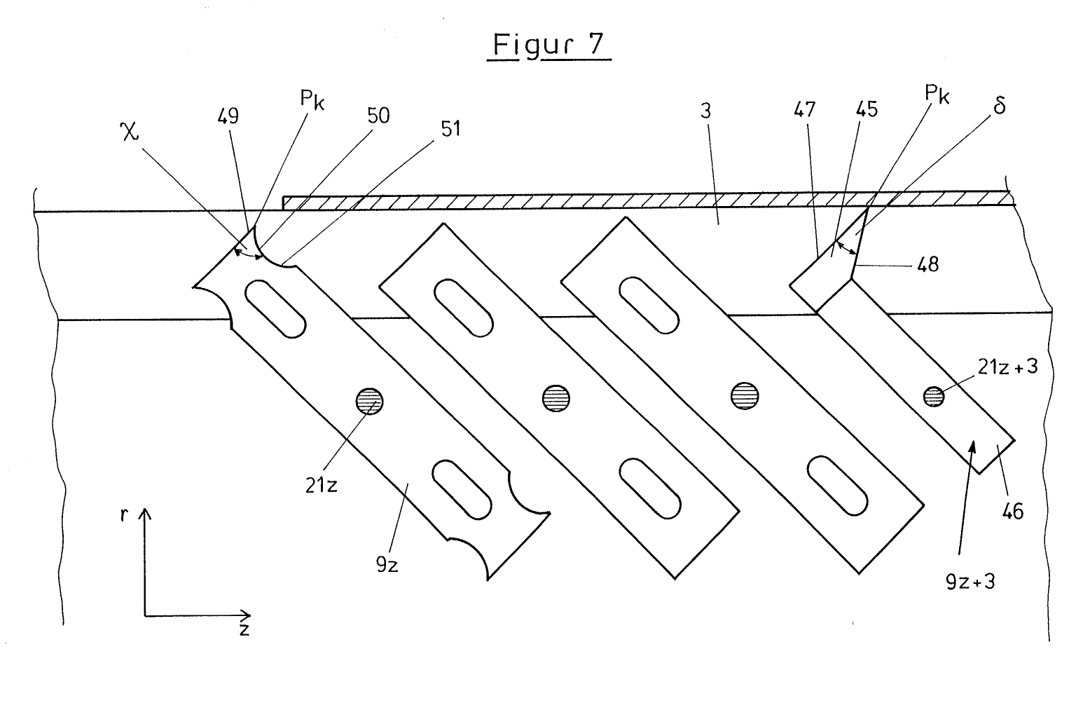

FIG. 7 is a sketch of several knives with exemplary shaped cutting blades, which further facilitate the cutting process.

FIG. 1 is a sectional view of a cutting and transport roller 1, according to the invention. The cutting and transport roller 1 is cut along the plane, defined by the radial and angular coordinates of the roller. Within the shell 3 of the cutting and transport roller 1 there is also the cutter 4 with the knives 9, which in this presentation are reaching through the knife slit 6. The material web 7, which normally rests against the shell 3 and is being cut in this knife position, is not drawn for the sake of a better overview.

The entire cutter 4 is housed in a box 2, which in turn is attached to the inside of the shell 3 of the roller 1.

To permit a view of the interior of the box 2 of the cutter 4 in FIG. 1, the vertical wall 40b of the box of the cutter is broken open.

In the illustrated embodiment, the cutter bar comprises in essence a T profile 10. Below the horizontal overhang of the T profile an Origa cylinder 39 is attached to the floor 42 of the box 2. The Origa cylinder was drawn as a square for reasons relating to the graphical presentation.

The Origa cylinder 39 has a cone 41, which reaches through the slit 43 in the horizontal overhang 11 of the T profile and moves the carriage 13 of the pull-thrust rod 14 during the cutting process.

Usually the cutting and transport roller rotates during the cutting process around its main axis of symmetry 24. In the rest of the description the invention is presented primarily with reference to the coordinate system of the cylinder of the cutting and transport roller that has already been sketched in FIG. 1.

The details of the function of the cutter bar are sketched in FIG. 2.

FIG. 2 depicts the cutter bar 8 of the inventive cutter, which has already been shown in FIG. 1. For reasons relating to a better overview, the cutting and transport roller 1, which contains the cutter, the entire holding mechanism of the cutter bar and the Origa cylinder are not shown.

The base element of the cutter bar is a T profile 10, to which various components are attached. A locking plate 12 is mounted on the horizontal overhang 11 of the T profile 10. The carriage 13 of the pull-thrust rod 14 can slide with negligible clearance between the locking plate 12 and the horizontal overhang of the T profile, when it is driven through the slit 43 in the horizontal overhang 11 by means of the cones 41 of the Origa cylinder 39. Said cones are not shown in FIG. 2. The pull and thrust rod 14 has boreholes 15, through which the cones 16 reach.

These cones also reach through the oblong holes 17 of the knives 9. Said holes are not visible in FIG. 2.

The knives 9 can slide with negligible clearance in the space between the vertical overhang 18 of the T profile 18 and the guide plate 19. In the illustrated embodiment of the invention, the knives 9 are provided with guide beads 20, which can be made, for example of teflon. The bolts 21 reach through the vertical overhang 18 of the T beam 10, the guide plate 19 and the knives 9 and form the point of rotation for the knives 9. The axis of rotation for the knives is labelled D in FIG. 2.

During the cutting process the thrust and pull rod 14 is driven, as stated above, by the Origa cylinder 39. However, the rotational motion, required to carry out the cutting process, can also be induced by any other suitable device, which provides a force or generates directly a torque. This device can be, among other things, a normal pneumatic cylinder, an electric linear drive or a normal electric machine.

During its linear motion the pull and thrust rod 14 moves the cones 16, which reach through the oblong holes 17 of the knives 9 and transfer in this manner the force to the knives 9. Thus, the knives 9 are put into rotational motion. The rotational or swivel motion of the knives 9, depicted in this embodiment, sweeps an angle of significantly less than 360 degrees. The swivel motion of an individual knife 9 is shown in detail in the Figure.

FIG. 3 is a drawing of a cutting motion of several knives of a cutter. In this Figure the oblong holes 17ₙ of the knives 9ₙ are also depicted. In this embodiment the spacing Aᵣ between the knives 9ₙ is significantly less than the cutting lengths Sₙ of the respective knives 9ₙ. The dashed line 22 indicates the position of the cutting surface 9aₙ at the end of the cutting process of the knife 9n. The bolts 21ₙ define the point of rotation of the knives 9ₙ.

FIG. 4 is a sketch, which shows in detail once again the cutting motion of a single knife 9 with the two cutting surfaces 9a and 9b.

Before the start of the cutting process, the knife is located in the resting position R₁. In this position the knife 9 is depicted broken. During the cutting process the knife 9 rotates around the bolt 21. At the start of the cutting process the knife exerts a force F₁ on the film, which in the radial direction (r) leads away from the main axis of symmetry of the cutting and transport roller. However, the material web 7 has not been completely severed during this period so that it contributes to the process of forcing the material web against the roller by maintaining the web tension and optionally by partially looping the film around the roller 1. The effect of the force F₁ on the film is terminated, when the knife reaches the apex Pₛ during the cutting process. After passing the apex Pₛ, the knife 9 applies a force effect F₂ on the material web that supports the forcing of the material web against the roller 1.

At the end of the cutting process the knife 9 has introduced a cut having a cut length S into the material web 7. The knife remains in the second resting position R₂. The knife 9 also has a second cutting surface 9b and can, therefore, also cut, when the cutting process is carried out in the opposite direction.

FIG. 5 is a drawing of a cutting process, wherein a first group N of knives 9n, 9n−1, etc. carries out a rotational motion with negative direction of rotation during the cutting process, whereas a second group M of knives 9m, 9m+1, etc. makes a rotational motion with a positive direction of rotation. The knife 9n sweeps an angle -alpha. The different cutting direction of the two groups of knives M and N is shown once again by means of the curved arrows 22_{N} and 22_{M}.

In this manner the opposite rotational motion of the knife blades of the two groups N and M results in two forces, whose axial components F_{N} and F_{M} act in the opposite direction. Owing to these measures the resulting total force F_{G}, which acts on the film in the axial direction during the cutting process, is reduced.

It is possible to coordinate in such a manner the cutting forces, which belong to the two groups of knives Fₙ and Fₘ and which act in the axial direction that the resulting total force F_{G}, which is exerted on the film in the axial direction, largely disappears.

In the illustrated embodiment, the cut lengths of the knives are coordinated in such a manner that the result is a continuous cut over the entire width of the material web 7. In coordinating the cutting motion of adjacent knives with the cutting motion of a different sense of rotation - - - in FIG. 5 this description applies to the knives 9ₙ and 9ₘ - - - , a collision of the two knives must also be avoided. To this end, it can be provided that the knife 9m does not reach the overlap point O until the knife 9n has already completed the cutting process and its entire width is located inside the radius of the film reel R_{F}.

FIG. 5 also shows that it is possible with the aid of an individual force, which acts here in the axial direction, to generate the opposite rotational motion of both groups of knives N and M.

In the illustrated embodiment, the thrust and pull rod 23 reaches for this purpose with the cone 16n underneath the point of rotation 21n into the non-illustrated oblong holes 17 of the knives 9n, 9n−1 of the group N. In this embodiment the pull and thrust rod 23 is running in the axial direction—thus parallel to the main axis of symmetry 24 of the roller. However, the knives of the groups N and M are made differently. Thus, the bolts 21n of the group N are located above the thrust and pull rod 23, whereas the bolts 21m of the other group M are disposed below the rod 23. With simple means of this kind the opposite motion of rotation of the two groups of knives N and M can be induced with a single force. Mechanisms, which realize the rotational motion of the two groups of knives with the aid of drive units, like an electric machine, which provides immediately a torque, instead of a force, can be provided with similar simple torque reversing mechanisms. In this manner the opposite motion of rotation of both groups of knives can be induced by one drive unit.

The knives of both groups of knives can also be arranged less uniformly than depicted in the example. Thus, an alternating arrangement of the knives from both groups N and M is also conceivable.

FIG. 6 shows another embodiment of the invention with a circular cutter, which has a disk shaped, essentially round knife 25, which severs the film web 7, so that the severed film web 34 can be seen to the left of the round knife 25.

The round knife 25 rotates around the axle 26, which defines thus an axis of rotation 36 that runs perpendicular to the plane, which is defined by the axial (z) and radial (r) coordinates in the reference system of the roller. In this embodiment the rotational direction is shown by means of the curved arrow 38. Since the axis of rotation 36 extends beyond the drawing plane, it can be represented only as a point in FIG. 5.

The torque for the rotational motion is provided by the drive unit 28 and transferred from the shaft 29 over the belt 27 to the axle 26 in the point of rotation 36 of the knife 25.

During the cutting process the entire circular cutter 35 executes a translation in the axial direction (z). In FIG. 6 there is a motion in the direction, depicted by means of the straight arrow 37.

To this end, the circular cutter 35 is mounted on the carriage 30, which slides on the rail 31. The force for this linear motion is provided by the Origa cylinder 32, which transfers said force with the cone 33 to the carriage 30.

It must also be noted that the cutting process, shown in FIG. 6, can begin in different ways. Thus, the knife 25 can make contact with the material web 7 by means of a motion of the circular cutter 35 in the axial direction. This is possible especially when the width of the material web 7 is less than the maximum working width of the knife 25, which is defined by the length of the travel path of the carriage 30 and the length of the knife slit 6 in the shell 3 of the roller 1.

However, it is also possible for the knife 25 to make contact with the material web 7 by moving in the radial direction at the start of the cutting process. To this end, the carriage 30 can exhibit, for example, a lifting device, which can move the circular cutter in the radial direction (r).

In this respect it must be emphasized once again that it would be advantageous for all of the illustrated embodiments of the invention if the cutting motion were also supported with translatory components in the radial direction. To this end, a suitable lifting device can be provided in the radial direction below the cutter bar 8. Some of the claims below also disclose advantageous embodiments of devices and processes of this kind.

FIG. 7 is a drawing of several knives with exemplary shaped cutting blades, which further improve the cutting process.

To this end, knives are used that exhibit special shapes of these knives directly at the contact point P_{K}, where the knives 9_{z} and 9_{z+3} make contact with the material web 7 for the first time. Thus, the knife 9z has a semicircular recess 51 in the area of its cutting blade directly below the point Pₖ. The presence of this semicircular recess 51 results in an angleₓ between the upper area of the cutting edge 50 of the knife 9_{z} and the edge 49, which is less than 90 degrees. In this manner a force component is generated in the radial direction (r) during the cutting process of the knife 9_{z}, before the knife reaches the apex of the cutting motion Pₛ, shown in FIG. 4. In any event with these measures the force effect of the knife on the web is changed in an advantageous manner.

The knife 9_{z+3} consists of two parts 45 and 46. The part 45 is wedge shaped and shaped in such a manner that between the cutting edge 48 and the edge 47 there is an angle delta, which is also less than 90 degrees.

Both the knife 9_{z} and the knife 9_{z+3} are only exemplary shapes of knives that have edges, whose angle is less than 90 degrees and which already unfold the aforementioned force effect during an early phase of the cutting process, in the immediate vicinity of the point P_{K}. Especially advantageous is the use of knives of the described type on the edge of the material web 7, resting on the shell 3. However, the use of knives of the described kind for severing the material web 7 over its entire width can also be advantageous.

List of Reference Numerals

| | | | |
|---|---|---|---|
| Cutting and transport roller | 1 | | |
| Box of the cutter | 2 | | |
| Shell | 3 | | |
| Cutter | 4 | | |
| Knife | 5 | | |
| Knife slit | 6 | | |
| Material web | 7 | | |
| Cutter bar | 8 | | |
| Knife | 9 | 9ₙ | 9ₘ |
| T profile | 10 | | |
| Horizontal overhang ofthe T profile | 11 | | |
| Locking plate | 12 | | |
| Carriage of the pull and thrust rod | 13 | | |
| Pull and thrust rod | 14 | | |
| Boreholes | 15 | | |
| Cones | 16 | 16ₙ | 16ₘ |
| Oblong holes | 17 | 17ₙ | 17ₘ |
| Vertical overhang of the T profile | 18 | | |
| Guide plate | 19 | | |
| Guide bead | 20 | | |
| Bolt | 21 | | |
| Curved arrows in the direction of the | 22ₙ | 22ₘ | |
| sense of rotation | | | |
| Pull and thrust rod | 23 | | |
| Main axis of symmetry of the roller | 24 | | |
| Round knife | 25 | | |
| Axle of the round knife | 26 | | |
| Belt | 27 | | |
| Drive unit | 28 | | |
| Shaft | 29 | | |
| Carriage of the circular cutter | 30 | | |
| Rail | 31 | | |
| Origa cylinder | 32 | | |
| Cone of the Origa cylinder | 33 | | |
| Severed film web | 34 | | |
| Circular cutter | 35 | | |
| Axis of rotation of the round knife | 36 | | |
| Straight arrow | 37 | | |
| Curved arrow | 38 | | |
| Origa cylinder | | | |
| Vertical wall of the box of the cutter | 40a | 40b | |
| Cone of the Origa cylinder | 41 | | |
| Floor of the box of the cutter | 42 | | |
| Slit in the horizontal overhang of the T | 43 | | |
| profile | | | |
| Dashed line | 44 | | |
| Part of the knife 9_{z+3} | 45 | | |
| Part of the knife 9_{z+3} | 46 | | |
| Edge of the knife 9_{z+3} | 47 | | |
| Cutting edge of the knife 9_{z+3} | 48 | | |
| Edge of the knife 9_{z} | 49 | | |
| Upper part of the cutting edge of the | 50 | | |
| knife 9_{z} | | | |
| Semicircular recess of the knife 9_{z} | 51 | | |
| Radial coordinates | r | | |
| Axial coordinates | z | | |
| Angular coordinates | ψ | | |
| Spacing between the knives | Aᵣ | | |
| Cut lengths of the respective knives | Sn | Sm | |
| First resting position of the knife | R₁ | | |
| Second resting position of the knife | R₂ | | |
| Force effect on the film | F₁ | | |
| Force effect on the film | F₂ | | |
| Cutting surface | 9a | | |
| Cutting surface | 9b | | |
| Group of knives | N | | |
| Group of knives | M | | |
| Knife of the group of knives N | 9n, 9n−1 . . . | | |
| Knife of the group of knives M | 9m, 9m+1 . . . | | |
| Angle | −α | | |
| Angle | +β | | |
| Axial component of the force on the | Fₙ | | |
| material web | | | |
| Axial component of the force on the | Fₘ | | |
| material web | | | |
| Resulting axial component of force on the | F_{G} | | |
| material web | | | |
| Linear force | F_{L} | | |
| Radius of the film reel | R_{F} | | |
| Overlapping point of the cuffing motions | O | | |
| of the knives that belong to the different | | | |
| groups of knives N, M | | | |
| Axis of rotation of the knives | D | | |
| Apex of the knife | P_{S} | | |
| Point of contact between knife and | P_{K} | | |
| material web | | | |
| Angle | X | | |
| Angle | δ | | |

1. Cutting and transport roller, which exhibits an outer shell, provided with a slotted opening and contains a cutter for the material webs, said cutter severing the material web, which rests on the shell of the transport roller, whereby the cutter contains at least one knife, which is guided by a cutter holder and which in turn exhibits at least one cutting edge, whereby said at least one knife is hinged to the cutter holder so as to swivel and reaches through the opening in the shell during the cutting process of the material web, characterized in that the swivelable coupling of said at least one knife (9) defines for said at least one blade (9a) of the knife an axis of rotation, which runs either parallel or at an acute angle to a perpendicular line on the plane, which is defined by the radial (r) and the axial (z) coordinates of the cutting and transport roller (1).

2. Cutting and transport roller, as claimed in claim 1, characterized in that said at least one knife (9) is attached to a cutter bar (8), which can execute a translational motion in the radial and/or axial direction of the cutting and transport roller (1).

3. Cutting and transport roller, as claimed in claim 1 or 2, characterized by suction devices or vacuum chambers, which are located inside the shell of the cutting and transport roller and which have connections with openings in the shell of the cutting and transport roller.

4. Cutting and transport roller, as claimed in claim 3, characterized by mechanisms to open and close the connections between the suction devices or vacuum chambers inside the shell and the openings in the shell.

5. Cutting and transport roller, as claimed in any one of the preceding claims, characterized by a device, which is intended to provide a force and which is attached inside the shell of the cutting and transport cylinder and which transfers said force to a pull and thrust rod (14, 23), which is hinged to this knife and is offset in the radial direction of the cutting and transport roller (1) relative to the point of rotation of at least one knife (9).

6. Cutting and transport roller, as claimed in claim 5, characterized in that attached to the pull and thrust rod are cones (16), which reach through the oblong holes (17) in said at least one knife (9) and drive the knives.

7. Cutting and transport roller, as claimed in claim 5 or 6, characterized in that the pull and thrust rod (14) is designed as the carriage (13), which runs between the guide elements of the cutter.

8. Cutting and transport roller, as claimed in any one of the preceding claims, characterized in that said at least one knife (9) is made of a flat sheet metal-like material, whereby the material thickness is small compared to the width of the knife.

9. Cutting and transport roller, as claimed in any one of the preceding claims, characterized in that the cutter contains a plurality of knives (9ₙ, 9ₙ₊₁ . . . ) whose cutting blades (9a, 9b) exhibit in the respective resting position a spacing (Sₙ), which is less than or equal to the length of the cut, which the assigned knife (9ₙ) introduces into the material web.

10. Cutting and transport roller, as claimed in any one of the preceding claims, characterized in that the cutter contains knives (9) of varying length, or knives, which are hinged to points of rotation and are positioned so as to be offset in the radial direction of the roller.

11. Cutting and transport roller, as claimed in claim 2, characterized in that attached to the cutter bar is a circular cutter, which a disk shaped, essentially round knife puts into rotational motion preferably with an electric motor.

12. Process for cutting material webs, which rest on the peripheral surface of the cutting and transport roller, with the aid of a cutter, which is located substantially inside the shell of the cutting and transport roller in the resting position and exhibits said at least one knife, which reaches through an opening in the shell of the cutting and transport roller during the cutting process of the material web, characterized in that the cutting motion, which is executed by the cutting surfaces (9a, 9b) of said at least one knife during the cutting process, exhibits rotary components, whereby the rotational motion of said at least one knife runs about axes, which run either parallel or at an acute angle to a perpendicular lines on the plane, which is defined by the radial (r) and the axial (z) coordinates of the cutting and transport roller.

13. Process, as claimed in claim 12, characterized in that the cutting motion, which is executed by the cutting surfaces (9a, 9b) of said at least one knife during the cutting process, also exhibits translatory components.

14. Process, as claimed in any one of the preceding claims, characterized in that in the cutting process the cutting surfaces (9a, 9b) of said at least one knife sweep an angle that is less than 360 degrees.

15. Process, as claimed in claim 14, characterized by the sequence of the following process steps:
(a) before the start of the first cutting process, said at least one knife (9) rests in a first resting position (R₁) inside the shell (3) of the transport roller (1);
(b) in a first cutting process, in which a first cutting surface (9a) of said at least one knife (9) is used, said at least one knife (9) executes a rotational motion in a first direction of rotation and reaches a second resting position (R₂) inside the shell (3) of the transport roller (3);
(c) said at least one knife (9) remains until a second cutting process in the second resting position (R₂) inside the shell (3) of the transport roller;
(d) in a second cutting process, in which a second cutting surface (9b) of said at least one knife is used, said at least one knife (9) executes a cutting motion in the second direction of rotation, which is opposite the first direction of motion, and reaches in this manner again the first resting position (R₁) inside the shell of the transport roller.

17. Process, as claimed in any one of the preceding claims, characterized in that a force, which is provided inside the shell of the cylinder and whose purpose is to generate the swivel motion of said at least one knife, is converted mechanically into a torque.

18. Process, as claimed in any one of the preceding claims, characterized in that different knives of a cutter make at different times at least partial contact with the film web to be cut.

19. Process, as claimed in any one of the preceding claims, characterized in that the cutter contains several knives, of which at least one is assigned to a group of knives (N) and at least one other is assigned to a group of knives (M); and whereby during a cutting process said at least one knife (9ₙ) of the first group executes a cutting motion, whose rotary components have a sense of rotation that is opposite the sense of rotation of the rotary components of the cutting motion of said at least one knife (9ₘ) of the second group (M).

20. Process, as claimed in claim 19, characterized in that the rotational motions with the opposite sense of rotation, which the knives of both groups of knives (N, M) execute, are induced by converting a force, in that components of the force (F_{L}) are transferred to said at least one knife (9n) of the first group (N) in the radial direction below the axis of rotation of the knife motion (21n), whereas components of the linear force act on said at least one knife (9ₘ) of the second group (M) in the radial direction above the axis of rotation of the knife motion (21ₘ).

21. Process, as claimed in claim 19, characterized in that the rotational motions with the opposite sense of rotation, which the knives of both groups of knives (N, M) execute, are induced by means of a drive unit to provide a torque, whereby the torque for the second group of knives is converted with gearing means and transferred to the knives.

22. Process, as claimed in claim 12, characterized by the following process steps:
(a) a circular cutter, which is located in a first resting position, which permits the transport of material webs with the cutting and transport roller, puts a disk-shaped, essentially round knife (25) into rotation around its axis of rotation (36), whereby the said axis of rotation (36) lies parallel or at an acute angle to a perpendicular line on the plane, formed by the radial (r) and the axial components (z);
(b) the rotating, disk-shaped, essentially round knife (25) is brought into contact with the material webs (7) to be severed;
(c) the rotating, disk-shaped, essentially round knife (25) is put into a translation along the slotted opening (6) in the shell (3), so that the disk-shaped, essentially round knife (25) severs the material web (3), whereby the said translation runs in essence in the axial direction (z) along the slotted opening (6);
(d) the rotating, disk-shaped, essentially round knife (25) remains in a second resting position, which permits the transport of other material webs with the cutting and transport roller (1).

23. Process, as claimed in claim 22, characterized in that the rotating disk-shaped, essentially round knife (25) stands still between the cutting processes.

24. Process, as claimed in claim 22 or 23, characterized in that the rotating disk-shaped, essentially round knife (25) is moved back from the first into the second resting position after the cutting process.

25. Device and process, as claimed in any one of the preceding claims, characterized by at least one knife is used that in the immediate vicinity of the point (Pₖ), where at the start of the cutting process said at least one knife makes an initial contact with the material web, exhibits an upper edge (47, 49), which is at an angle (x, δ) that is less than 90 degrees with respect to said at least one cutting edge (48, 50).
